(19) United States
(12) Patent Application Publication
(10) Pub. No.: US 2019/0172240 A1
(43) Pub. Date: Jun. 6, 2019

(54) FACIAL ANIMATION FOR SOCIAL VIRTUAL REALITY (VR)

(71) Applicant: Sony Interactive Entertainment Inc., Tokyo (JP)

(72) Inventors: Marie Kitajima, San Mateo, CA (US); Masanori Omote, San Mateo, CA (US)

(21) Appl. No.: 15/833,680

(22) Filed: Dec. 6, 2017

(51) Int. Cl. G06T 13/20; G06T 13/40; G10L 15/08; G10L 15/22; G10L 15/30; G10L 13/04

(52) U.S. Cl. CPC G06T 13/205; G06T 13/40; G10L 15/08; G10L 2015/223; G10L 15/30; G10L 13/043; G10L 2015/088; G10L 15/22

(57) ABSTRACT

An avatar's lips are animated using visemes derived from a response to a digital assistant query in synchronization with playing the response.

### FIELD

The application relates generally to creating 3D facial animation for social VR applications.

### BACKGROUND

Apple Siri®, Microsoft Cortana®, Google Assistant™, Amazon Alexa™ and Line Corporation Clova™ are examples of digital assistants that instantiate “chatbots” to audibly respond to spoken queries from people to return answers to the queries. The term “chatbot or bot” as used herein refers to a program (or the entire system including it) that performs dialogue communication on behalf of humans. A dialogue may be a combination of an utterance (such as a query) from a person and a response from the chatbot to the utterance.

### SUMMARY

As understood herein, current digital assistants can be augmented by visibly showing a graphic of a chatbot character as it speaks, moving its lip in concert with the spoken answer to a query.

Accordingly, a device includes at least one computer memory that is not a transitory signal and that in turn includes instructions executable by at least one processor to receive an utterance from a person, and access a data structure based on the utterance to retrieve a response to the utterance. The instructions are executable to display the response. The instructions are further executable to, based at least in part on the response, generate a sequence of visemes and animate lips of an avatar presented on a display in synchronization with displaying the response.

In an example, the response is audibly displayed. To this end, the device can include at least one speaker for playing the response. The device may further include at least one display for presenting the avatar.

In some examples, the utterance includes at least a wakeup word and a skill name, and the instructions are executable to, responsive to the skill name, access a cloud-based service to return the response. The instructions are further executable to animate the lips of the avatar in synchronization with playing the response. In further detailed embodiments, the utterance can include a desired skill response, and the instructions can be executable to send the desired skill response to a data structure to receive a modification of the desired skill response therefrom. The modification of the desired skill response is played, e.g., on the speaker. In a specific example the desired skill response is in a first language and the modification of the desired skill response is in a second language different from the first language.

In another aspect, a computer-implemented digital assistant (DA) includes at least one microphone, at least one processor configured to receive input from the at least one microphone, and at least one speaker configured to play audio under control of the at least one processor. The DA further includes at least one display configured to present demanded images under control of the at least one processor. The processor is configured with executable instructions to execute a chatbot module that receives at least one utterance into the microphone from at least one person, accesses at least one data source to retrieve a response therefrom to the utterance, and play the response on the speaker. The instructions are executable to animate lips of an avatar presented on the display in synchrony with playing the response on the speaker.

In another aspect, a method includes using a digital assistant to receive a query, retrieve a response to the query, and play the response on a speaker. The method also includes using the digital assistant to derive at least one viseme from the response and animate an avatar using the viseme in synchrony with playing the response on the speaker.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system including an example in accordance with present principles;

FIG. 1A is a schematic diagram of a vehicle (such as a driverless vehicle) embodiment;

FIG. 1B is a schematic diagram of a mobile communication device (such as a mobile telephone) telephone embodiment;

FIG. 2 is a block diagram of an example digital assistant environment;

FIG. 3 is a schematic diagram of an audio-based solution system configuration;

FIG. 4 is a flow chart of example logic related to FIG. 3;

FIG. 5 is a schematic diagram of a custom skill system configuration; and

FIG. 6 is a flow chart of example logic related to FIG. 5.

### DETAILED DESCRIPTION

This disclosure relates generally to computer ecosystems including aspects of consumer electronics (CE) device networks such as but not limited to distributed computer game networks, video broadcasting, content delivery networks, virtual machines, and machine learning applications. Note that many embodiments of the instant chatbot are envisioned, with several, including driverless vehicles and mobile telephones, described and shown herein.

A system herein may include server and client components, connected over a network such that data may be exchanged between the client and server components. The client components may include one or more computing devices including game consoles such as Sony PlayStation® and related motherboards, portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Orbis or Linux operating systems, operating systems from Microsoft, or a Unix operating system, or operating systems produced by Apple, Inc. or Google. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may include one or more processors executing instructions that configure the servers to receive and transmit data over a network such as the Internet. Or, a client and server can be connected over a local intranet or a virtual private network. A server or controller may be instantiated by a game console and/or one or more motherboards thereof such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general-purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general-purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to Java, C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

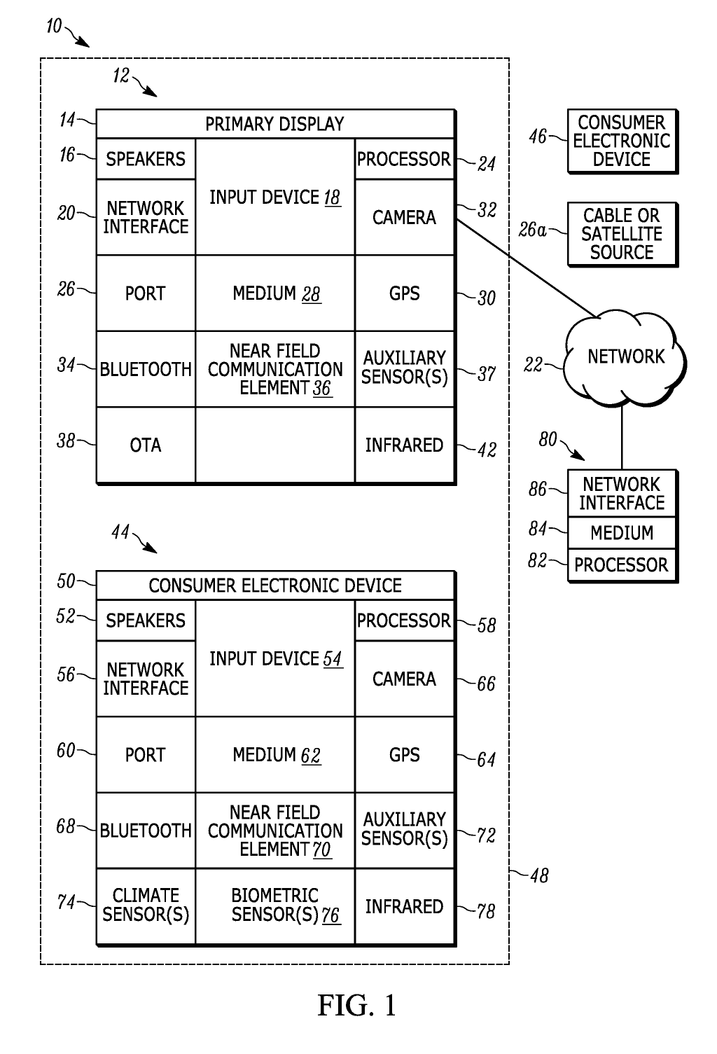

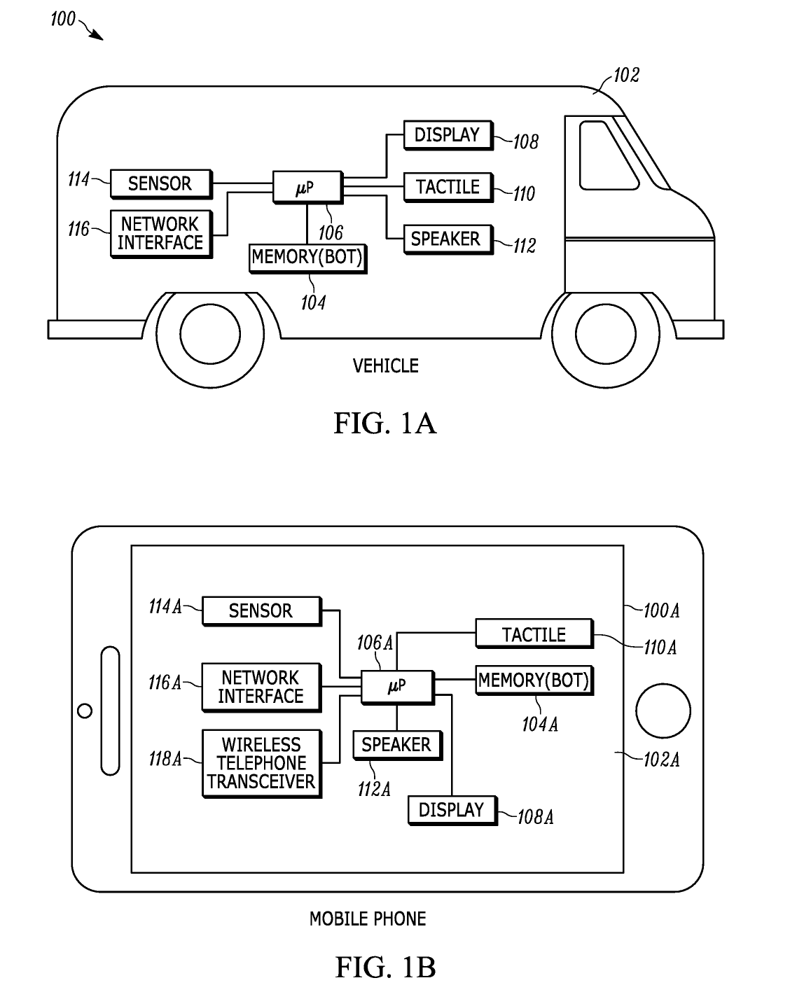

Now specifically referring to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to an Internet-enabled TV with a TV tuner (equivalently, set top box controlling a TV). However, the AVD 12 alternatively may be an appliance or household item, e.g. computerized Internet enabled refrigerator, washer, or dryer. The AVD 12 alternatively may also be a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the AVD 12 is configured to undertake present principles (e.g. communicate with other CE devices to undertake present principles, execute the logic described herein, and perform any other functions and/or operations described herein).

Accordingly, to undertake such principles the AVD 12 can be established by some or all of the components shown in FIG. 1. For example, the AVD 12 can include one or more displays 14 that may be implemented by a high definition or ultra-high definition “4K” or higher flat screen and that may be touch-enabled for receiving user input signals via touches on the display. The AVD 12 may include one or more speakers 16 for outputting audio in accordance with present principles, and at least one additional input device 18 such as e.g. an audio receiver/microphone for e.g. entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVD 12 may also include one or more input ports 26 such as, e.g., a high definition multimedia interface (HDMI) port or a USB port to physically connect (e.g. using a wired connection) to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be, e.g., a separate or integrated set top box, or a satellite receiver. Or, the source 26a may be a game console or disk player containing content that might be regarded by a user as a favorite for channel assignation purposes described further below. The source 26a when implemented as a game console may include some or all of the components described below in relation to the CE device 44.

The AVD 12 may further include one or more computer memories 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media. Also in some embodiments, the AVD 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the AVD 12 is disposed in conjunction with the processor 24. However, it is to be understood that that another suitable position receiver other than a cellphone receiver, GPS receiver and/or altimeter may be used in accordance with present principles to e.g. determine the location of the AVD 12 in e.g. all three dimensions.

Continuing the description of the AVD 12, in some embodiments the AVD 12 may include one or more cameras 32 that may be, e.g., a thermal imaging camera, a digital camera such as a webcam, and/or a camera integrated into the AVD 12 and controllable by the processor 24 to gather pictures/images and/or video in accordance with present principles. Also included on the AVD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 37 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the processor 24. The AVD 12 may include an over-the-air TV broadcast port 38 for receiving OTH TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12.

Still referring to FIG. 1, in addition to the AVD 12, the system 10 may include one or more other CE device types. In one example, a first CE device 44 may be used to control the display via commands sent through the below-described server while a second CE device 46 may include similar components as the first CE device 44 and hence will not be discussed in detail. In the example shown, only two CE devices 44, 46 are shown, it being understood that fewer or greater devices may be used. As alluded to above, the CE device 44/46 and/or the source 26a may be implemented by a game console. Or, one or more of the CE devices 44/46 may be implemented by devices sold under the trademarks Google Chromecast™, Roku®. A CE device may be established by a digital assistant, an example of which is shown and described further below.

In the example shown, to illustrate present principles all three devices 12, 44, 46 are assumed to be members of an entertainment network in, e.g., a home, or at least to be present in proximity to each other in a location such as a house. However, for present principles are not limited to a particular location, illustrated by dashed lines 48, unless explicitly claimed otherwise.

The example non-limiting first CE device 44 may be established by any one of the above-mentioned devices, for example, a digital assistant, a portable wireless laptop computer or notebook computer or game controller (also referred to as “console”), and accordingly may have one or more of the components described below. The second CE device 46 without limitation may be established by a video disk player such as a Blu-ray player, a game console, and the like. The first CE device 44 may be a remote control (RC) for, e.g., issuing AV play and pause commands to the AVD 12, or it may be a more sophisticated device such as a tablet computer, a game controller communicating via wired or wireless link with a game console implemented by the second CE device 46 and controlling video game presentation on the AVD 12, a personal computer, a wireless telephone, etc.

Accordingly, the first CE device 44 may include one or more displays 50 that may be touch-enabled for receiving user input signals via touches on the display. The first CE device 44 may include one or more speakers 52 for outputting audio in accordance with present principles, and at least one additional input device 54 such as e.g. an audio receiver/microphone for e.g. entering audible commands to the first CE device 44 to control the device 44. The example first CE device 44 may also include one or more network interfaces 56 for communication over the network 22 under control of one or more CE device processors 58. Thus, the interface 56 may be, without limitation, a Wi-Fi transceiver, which is an example of a wireless computer network interface, including mesh network interfaces. It is to be understood that the processor 58 controls the first CE device 44 to undertake present principles, including the other elements of the first CE device 44 described herein such as e.g. controlling the display 50 to present images thereon and receiving input therefrom. Furthermore, note the network interface 56 may be, e.g., a wired or wireless modem or router, or other appropriate interface such as, e.g., a wireless telephony transceiver, or Wi-Fi transceiver as mentioned above, etc.

In addition to the foregoing, the first CE device 44 may also include one or more input ports 60 such as, e.g., a HDMI port or a USB port to physically connect (e.g. using a wired connection) to another CE device and/or a headphone port to connect headphones to the first CE device 44 for presentation of audio from the first CE device 44 to a user through the headphones. The first CE device 44 may further include one or more tangible computer readable storage medium 62 such as disk-based or solid-state storage. Also in some embodiments, the first CE device 44 can include a position or location receiver such as but not limited to a cellphone and/or GPS receiver and/or altimeter 64 that is configured to e.g. receive geographic position information from at least one satellite and/or cell tower, using triangulation, and provide the information to the CE device processor 58 and/or determine an altitude at which the first CE device 44 is disposed in conjunction with the CE device processor 58. However, it is to be understood that that another suitable position receiver other than a cellphone and/or GPS receiver and/or altimeter may be used in accordance with present principles to e.g. determine the location of the first CE device 44 in e.g. all three dimensions.

Continuing the description of the first CE device 44, in some embodiments the first CE device 44 may include one or more cameras 66 that may be, e.g., a thermal imaging camera, a digital camera such as a webcam, and/or a camera integrated into the first CE device 44 and controllable by the CE device processor 58 to gather pictures/images and/or video in accordance with present principles. Also included on the first CE device 44 may be a Bluetooth transceiver 68 and other Near Field Communication (NFC) element 70 for communication with other devices using Bluetooth and/or NFC technology, respectively. An example NFC element can be a radio frequency identification (RFID) element.

Further still, the first CE device 44 may include one or more auxiliary sensors 72 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the CE device processor 58. The first CE device 44 may include still other sensors such as e.g. one or more climate sensors 74 (e.g. barometers, humidity sensors, wind sensors, light sensors, temperature sensors, etc.) and/or one or more biometric sensors 76 providing input to the CE device processor 58. In addition to the foregoing, it is noted that in some embodiments the first CE device 44 may also include an infrared (IR) transmitter and/or IR receiver and/or IR transceiver 78 such as an IR data association (IRDA) device. A battery (not shown) may be provided for powering the first CE device 44. The CE device 44 may communicate with the AVD 12 through any of the above-described communication modes and related components.

The second CE device 46 may include some or all of the components shown for the CE device 44. Either one or both CE devices may be powered by one or more batteries.

Now in reference to the afore-mentioned at least one server 80, it includes at least one server processor 82, at least one tangible computer readable storage medium 84 such as disk-based or solid-state storage. In an implementation, the medium 84 includes one or more solid state storage drives (SSDs). The server also includes at least one network interface 86 that allows for communication with the other devices of FIG. 1 over the network 22, and indeed may facilitate communication between servers and client devices in accordance with present principles. Note that the network interface 86 may be, e.g., a wired or wireless modem or router, Wi-Fi transceiver, or other appropriate interface such as, e.g., a wireless telephony transceiver. The network interface 86 may be a remote direct memory access (RDMA) interface that directly connects the medium 84 to a network such as a so-called “fabric” without passing through the server processor 82. The network may include an Ethernet network and/or fiber channel network and/or InfiniBand network. Typically, the server 80 includes multiple processors in multiple computers referred to as “blades” that may be arranged in a physical server “stack”.

Accordingly, in some embodiments the server 80 may be an Internet server or an entire “server farm”, and may include and perform “cloud” functions such that the devices of the system 10 may access a “cloud” environment via the server 80 in example embodiments for, e.g., network gaming applications, digital assistant applications, etc. Or, the server 80 may be implemented by one or more game consoles or other computers in the same room as the other devices shown in FIG. 1 or nearby.

The methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may be embodied in a non-transitory device such as a CD ROM or Flash drive. The software code instructions may alternatively be embodied in a transitory arrangement such as a radio or optical signal, or via a download over the internet.

FIG. 1A shows a specific non-limiting example in which a system 100 includes a vehicle 102 such as a driverless vehicle in which a chatbot application consistent with present principles has been downloaded from the cloud, such as a server 80, onto one or more computer memories 104, which may be implemented by any of the computer storage devices described herein. The chatbot application can be executed by one or more processors 106 to output information as further disclosed below on one or more output devices, including a visual display 108 such as a flat panel display, a tactile signal generator 110 such as a buzzer or other device that generates tactile signals, and one or more audio speakers 112. The processor 106 may receive input from one or more sensors 114 such as microphones, cameras, biometric sensors. The processor 106 may communicate with a network such as the Internet using one or more wired or more typically wireless network interfaces 116 such as but not limited to Wi-Fi.

FIG. 1B shows another specific non-limiting example in which a system 100A includes a mobile communication device (MCD) 102A such as a mobile telephone in which a chatbot application consistent with present principles has been downloaded from the cloud, such as a server 80, onto one or more computer memories 104A, which may be implemented by any of the computer storage devices described herein. The chatbot application can be executed by one or more processors 106A to output information as further disclosed below on one or more output devices, including a visual display 108A such as a flat panel display, a tactile signal generator 110A such as a buzzer or other device that generates tactile signals, and one or more audio speakers 112A. The processor 106A may receive input from one or more sensors 114A such as microphones, cameras, biometric sensors. The processor 106A may communicate with a network such as the Internet using one or more wired or more typically wireless network interfaces 116A such as but not limited to Wi-Fi. The MCD may also include one or more wireless telephony transceivers 118A such as but not limited to code division multiple access (CDMA) transceivers, global system for mobile communication (GSM) transceivers, etc.

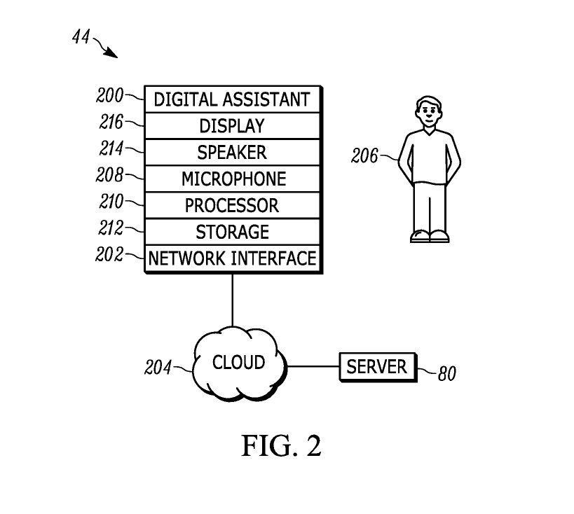

FIG. 2 illustrates an example application of a CE device 44 implemented by a digital assistant 200 communicating, via a network interface 202 such as a Wi-Fi or other appropriate wired or wireless interface with the Internet 204 and thence with one or more servers 80 to exchange information therewith. A person 206 can speak into a microphone 208 of the digital assistant 200 and the person's voice is digitized for analysis using speech recognition by a processor 210 accessing instructions on a computer memory or storage 212 such as disk-based or solid-state storage. The digital assistant responds to queries from the person 206 by accessing data on the server 80 and/or storage 212 and converting query results to audible signals that are played on one or more speakers 214 and/or presented on one or more visual displays 216.

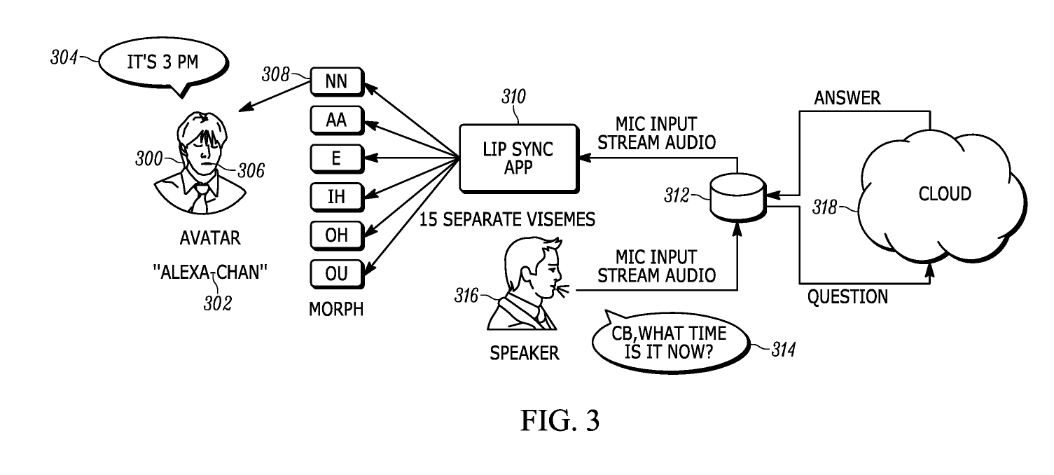

Now referring to FIG. 3, an animated avatar 300 may be presented on any of the displays herein with a fictional name 302. As indicated at 304, along with presenting the image of the avatar 300, speech may be played on any of the speakers disclosed herein. In synchrony with playing the speech, the lips 306 of the avatar 300 are caused to move to mimic visemes 308 that a person would make in articulating the words of the speech 304.

The visemes 308 are graphic instructions to cause a processor to establish a configuration of the lips 306, and to this end may come from a lip synchronization module 310 receiving audio input from a chatbot source 312 such as a digital assistant (e.g., the digital assistant 200 shown in FIG. 2) having a microphone and/or storing or streaming digital audio tracks. The audio input to the lip synchronization module 310 may be in response to speech 314 such as a query spoken by a human speaker 316 into the digital assistant 312 and processed by the digital assistant 312 and/or sent for processing to a cloud server 318, which returns a response to the human-originated speech 314.

In one embodiment, the digital assistant 312 may execute the lip synchronization module 310, which may be implemented by the techniques discussed in the present assignee's U.S. Pat. No. 8,743,125, incorporated herein by reference. The LipSync application may be implemented in an example embodiment by the Oculus OVRLipSync for Unity system, which outputs fifteen separate viseme targets. In an example implementation, only visemes representing vowels in the response may be used in the animated morphing of the lips 306 of the avatar 300, with other visemes being mapped to “nn” (closed lips). In other implementations, visemes representing consonants may be used to animate the lips.

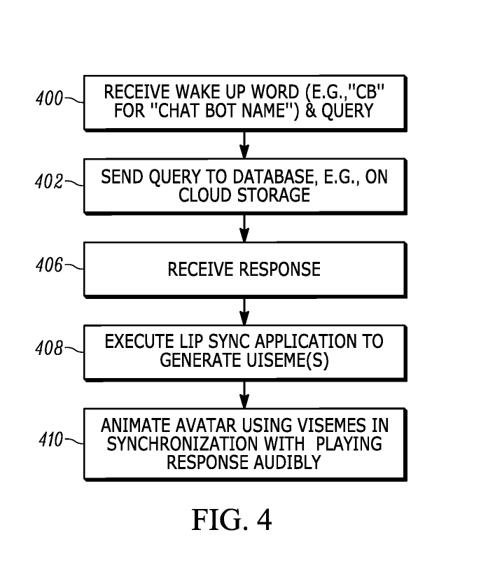

FIG. 4 illustrates example logic that may be implemented by the processor (e.g., the processor 210) of the digital assistant. Commencing at block 400, a wakeup word such as the name 302 of the chatbot may be received along with an ensuing query from the human user 316. The query, in response to the wakeup word alerting the digital assistant to its existence, is used as entering argument to a database at block 402 to retrieve a response at block 406. The database may be local to the digital assistant or it may be a cloud server 318 database.

The response is input as an audio stream to the lip synchronization module 310, which executes to generate visemes at block 408. The visemes are used to animate the lips 306 of the avatar 300 in FIG. 3 in synchrony with playing the response on speakers such as the speakers 214 in FIG. 2.

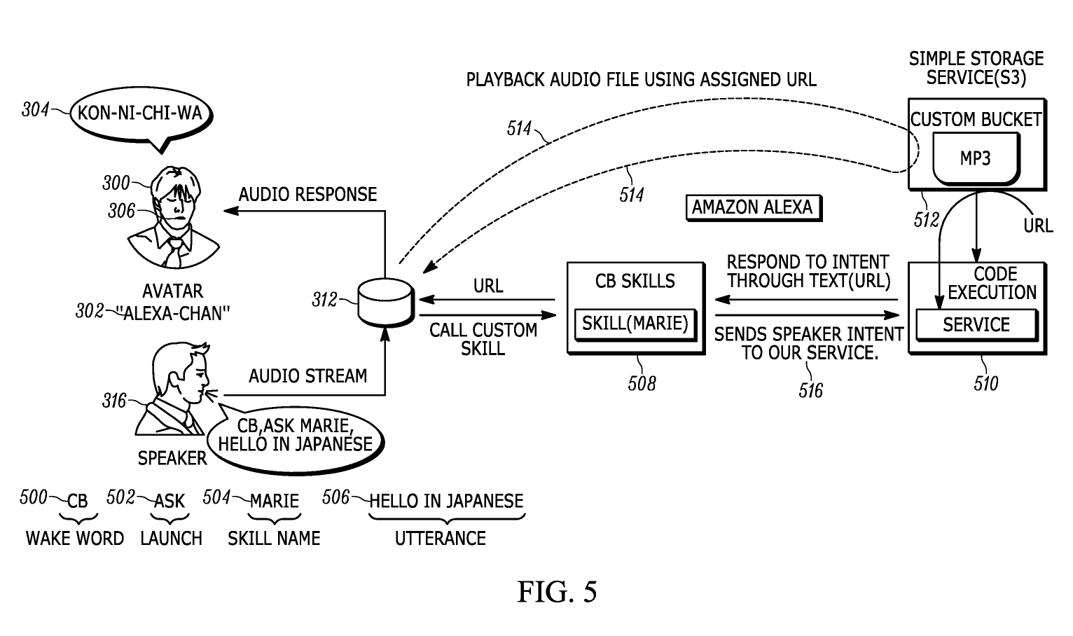

FIG. 5 illustrates an example similar to that of FIG. 3 in which the lips 306 of the avatar 300 are moved in synchrony with playing query responses on the speakers of a digital assistant 312 in response to queries from a human 316, with the difference being that in FIG. 5 a custom skill is implemented by the system. An example custom skill may be the ability to speak Japanese by a digital assistant that ordinarily does not have Japanese language capability.

As schematically shown in the example of FIG. 5, a wakeup word 500 such as the name 302 of the chatbot is first received to alert the digital assistant that an incoming query is about to be spoken. A launch word 502 is then spoken by the human to initiate the custom skill processing, followed by a skill name 504 to initiate the specific custom skill sought to be invoked. Then, the human speaks the desired output 506 of the custom skill. In the example shown, the human desires to listen to a Japanese translation of the English word “hello”.

Having received the custom skill processing launch word, the specific custom skill sought to be invoked (in this example, English-to-Japanese translation), and the desired output thereof (“hello” in Japanese), the digital assistant may send a call for the specific skill and desired outcome to a skill engine 508, which may be implemented by a cloud server. The skill engine 508 may access a cloud-based code execution service 510 that in turn can access a cloud-based simple storage service 512 using the desired outcome 506 to retrieve the desired outcome modified by the custom skill processing and return it to the skill engine 508.

In the example shown, the code execution service 510 receives the desired outcome in English and inputs the English as entering argument to the storage service 512, which matches the input (e.g., using a table lookup or other matching algorithm) to the custom skill output sought, in this case, an audio file of “hello” in Japanese. The audio file is returned to the digital assistant 312 for playing thereof on speakers in synchrony with accompanying visemes animating the lips 306 of the avatar 300.

Note that in the example of FIG. 5, the digital assistant 312 may communicate directly with the storage service 512 using a bidirectional communication path 514 and may also communicate with the code execution service 510 through the skill engine 508 using a different bidirectional communication path 516.

Thus, when the wakeup word (such as “CB”) is used followed by a launch word (such as “ask”) and then the name of the custom skill (in this case, “Marie”), the query may be sent to a cloud server as in FIG. 3, except that a code execution service on the cloud that executes the customization (as may have been previously uploaded to the service) returns a response by accessing a simple storage service database, customized accord to the customization. In the example shown, the simple storage service may store pre-recorded audio files in a customized language, e.g., Japanese. The response may be via text and/or audio, with the response used as above to generate visemes that are used to animate the avatar's lips.

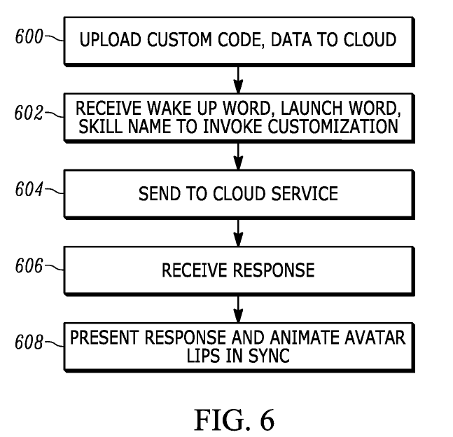

FIG. 6 is a flow chart of example logic consistent with FIG. 5. Initially, the custom code and associated audio files to respond to the skill launch words 502-506 are uploaded to the cloud at block 600, e.g., to the code execution service 510 and storage service 512. Then, at block 602, responsive to receiving a correct wakeup word 500 the digital assistant listens for an ask word 502 followed by a skill name 504 and desired output 506 to invoke the customization feature shown in FIG. 5. Upon receipt of valid terms 502-506 the request is sent to the cloud services in FIG. 5 at block 604 of FIG. 6. The response (in the running example, an audio file) is received at block 606. The audio file is played on speakers in synchrony with generating visemes from the audio file and using the visemes to move the lips of the avatar in block 608.

It will be appreciated that whilst present principals have been described with reference to some example embodiments, these are not intended to be limiting, and that various alternative arrangements may be used to implement the subject matter claimed herein

What is claimed is:

1. A device comprising:
at least one computer memory that is not a transitory signal and that comprises instructions executable by at least one processor to:
receive an utterance from a person;
access a data structure based on the utterance to retrieve a response to the utterance;
display the response;
based at least in part on the response, generate a sequence of visemes; and
animate lips of an avatar presented on a display in synchronization with displaying the response.

2. The device of claim 1, herein the response is audibly displayed.

3. The device of claim 2, comprising at least one speaker for playing the response.

4. The device of claim 1, comprising at least one display for presenting the avatar.

5. The device of claim 1, wherein the utterance comprises at least a wakeup word and a skill name, and the instructions are executable to:
responsive to the skill name, access a cloud-based service to return the response; and
animate the lips of the avatar in synchronization with playing the response.

6. The device of claim 1, wherein the utterance comprises a desired skill response, and the instructions are executable to:
send the desired skill response to a data structure receive a modification of the desired skill response therefrom; and
play the modification of the desired skill response.

7. The device of claim 6, wherein the desired skill response is in a first language and the modification of the desired skill response is in a second language different from the first language.

8. The device of claim 1, comprising the at least one processor.

9. A computer-implemented digital assistant (DA), comprising:
at least one microphone;
at least one processor configured to receive input from the at least one microphone;
at least one speaker configured to play audio under control of the at least one processor;
at least one display configured to present demanded images under control of the at least one processor;
the at least one processor being configured with executable instructions to:
execute a chatbot module that receives at least one utterance into the at least one microphone from at least one person, accesses at least one data source to retrieve a response therefrom to the at least one utterance, and play the response on the at least one speaker; and
animate lips of an avatar presented on the at least one display in synchrony with playing the response on the at least one speaker.

10. The DA of claim 9, wherein the instructions are executable to:
based at least in part on the response, generate a sequence of visemes; and
animate the lips of the avatar in synchronization with displaying the response.

11. The DA claim 9, wherein the at least one utterance comprises at least a wakeup word and a skill name, and the instructions are executable to:
responsive to the skill name, access a cloud-based service to return the response; and
animate the lips of the avatar in synchronization with playing the response.

12. The DA of claim 11; wherein the at least one utterance comprises a desired skill response; and the instructions are executable to:
send the desired skill response to a data structure to receive a modification of the desired skill response therefrom; and
play the modification of the desired skill response.

13. The DA of claim 12, wherein the desired skill response is in a first language and the modification of the desired skill response is in a second language different from the first language.

14. A method comprising:
using a digital assistant, receive a query;
using the digital assistant, retrieving a response to the query;
using the digital assistant, play the response on a speaker;
using the digital assistant, derive at least one viseme from the response; and
using the digital assistant, animate an avatar using the at least one viseme in synchrony with playing the response on the speaker.

15. The method of claim 14, wherein the query comprises at least a wakeup word and a skill name, and the method comprises:
responsive to the skill name, accessing a cloud-based service to return the response; and
animating the lips of the avatar in synchronization with playing the response.

16. The method of claim 15, wherein the query comprises a desired skill response, and the method comprises:
sending the desired skill response to a data structure to receive a modification of the desired skill response therefrom; and
playing the modification of the desired skill response.

17. The method of claim 16, wherein the desired skill response is in a first language and the modification of the desired skill response is in a second language different from the first language.
